(19) United States
(12) Patent Application Publication
(10) Pub. No.: US 2005/0212343 A1
(43) Pub. Date: Sep. 29, 2005

(54) Head rest apparatus

(75) Inventor: Satoshi Katahira, Yokohama-shi (JP)

Correspondence Address: Edward L. McMahon;Ohlandt, Greeley, Ruggiero & Perle, L.L.P., 10th Floor, One Landmark Square, Stamford, CT, 06901-2682, US

(73) Assignee: NHK Spring Co., LTD.

(21) Appl. No.: 11/091,138

(22) Filed: Mar. 28, 2005

(30) Foreign Application Priority Data
Mar. 29, 2004 (JP) 2004-096437

(51) Int. Cl. B60K 41/22

(52) U.S. Cl. 297/410

(57) ABSTRACT

A head rest apparatus includes a head rest main body, a stay member, a holder, an operating member, an operating grip section, and a lock member. The operating member includes a slippage preventive engaging section which engages with a slippage preventive locking groove of the stay member. The operating grip section is provided at the operating member. The operating member is provided at the holder, and the operating grip section protrudes from the holder to the outside. The lock member is inserted through the holder and the operating member. The lock member holds the operating member at a home position. After the lock member has been removed, when the operating member is moved from the home position to a slippage preventive release position, the slippage preventive engaging section is disengaged from the slippage preventive locking groove.

### CROSS-REFERENCE TO RELATED APPLICATIONS

This application is based upon and claims the benefit of priority from prior Japanese Patent Application No. 2004-096437, filed Mar. 29, 2004, the entire contents of which are incorporated herein by reference.

### BACKGROUND OF THE INVENTION

1. Field of the Invention

The present invention relates to a head rest apparatus provided on a seat for a vehicle such as an automobile.

2. Description of the Related Art

An automobile seat comprises a slippage preventive mechanism in order to maintain safety of an occupant. The slippage preventive mechanism prevents a head rest main body from easily slipping off from a seat back. For example, Jpn. Pat. Appln. KOKAI Publication No. 2002-360372 discloses such a slippage preventive mechanism.

The slippage preventive mechanism of this type comprises a lock groove formed at a stay member and a lock tool which engages with the lock groove. This lock tool is provided at a holder through which the stay member is to be inserted. The lock tool can move in a direction crossing the stay member. The lock tool and the lock groove are engaged with each other, thereby preventing the head rest from slipping off from the seat back.

The lock tool and the lock groove are disengaged from each other by inserting a straight-slot screw-driver through a tool hole provided at the upper part of a holder and rotating the straight-slot screwdriver.

Specifically, a distal end part of the inserted the straight-slot screwdriver rotates, whereby an edge of the distal end part abuts against an edge of the lock tool. Then, the lock tool is moved until the lock tool and the lock groove are disengaged from each other.

However, in the above slippage preventive mechanism disclosed in Jpn. Pat. Appln. KOKAI Publication No. 2002-360372, it is necessary to form a tool hole through which the straight-slot screwdriver is to be inserted at the holder in order to move the lock tool.

Therefore, it is considered that dust or dirt is clogged in the holder through the tool hole. Thus, it is considered that the straight-slot screwdriver cannot be inserted into the tool hole, and the head rest cannot be pulled out.

### BRIEF SUMMARY OF THE INVENTION

It is an object of the present invention to provide a head rest apparatus capable of maintaining safety of an occupant and pulling out a head rest main body as required.

A head rest apparatus according to the present invention comprises: a head rest main body; a stay member provided at the head rest main body; a holder which is inserted through the stay member and fixed to a seat back; an operating member provided at the holder; an operating grip section which is provided at the operating member and extends from the holder to the outside; and a lock member.

A slippage preventive locking groove is provided at the stay member. The holder has a hole. The operating member comprises a slippage preventive engaging section which engages with the slippage preventive locking groove. The operating member has a hole. The operating member can move in a direction crossing the stay member. The slippage preventive engaging section can engage with the slippage preventive locking groove when the operating member is set at a home position. The lock member is inserted into the holes that are provided at the holder and the operating member. The lock member can hold the operating member at a home position and is removed from the holder and the operating member by means of a tool. The slippage preventive engaging section being disengaged from the slippage preventive locking groove when the lock member is removed and the operating member is moved from the home position to a slippage preventive release position.

In the head rest having such a structure, the lock member is removed, and the operating grip section is operated to move the operating member to the slippage preventive release position, whereby the head rest main body is pulled out. Thus, a hole through which the tool is inserted is prevented from being formed at the holder. Namely, there is no case in which the head rest main body cannot be pulled out due to the accumulation of dust or dirt.

Therefore, the head rest apparatus ensures the safety of an occupant and can pull out the head rest main body as required.

In a preferred embodiment of the present invention, the stay member has a height-adjustment locking groove facing away from the slippage-preventive locking groove. The operating member has a height-adjustment engaging section which engages with the height-adjustment locking groove when the operating member is set at the home position and which is opposed to the slippage preventive engaging section, across the stay member, while the stay member remains the height-adjustment section and the slippage preventive engaging section. The hole of the operating member which is inserted through the lock member is elongated hole through which the operating member is to move to a position where the height-adjustment engaging section is disengaged from the height-adjustment locking groove.

The operating member functions as an operating member for height adjustment and as an operating member for slippage prevention.

With this construction, because the operating member functions as a operating member for height adjustment and as an operating member for slippage prevention, a mechanism for slippage prevention of the head rest main body and a mechanism for height adjustment are configured with a simple structure. In a preferred embodiment of the present invention, a cutout section is provided at the stay member. This cutout section is provided at a side identical to the height adjustment locking groove. At the cutout section, when the operating member is moved to the slippage preventive release position, the height adjustment engaging section can be advanced into the cut out section.

With this construction, after the lock member has been removed, the slippage preventive engaging section can be easily disengaged from the slippage preventive locking groove.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing a seat according to a first embodiment of the present invention;

FIG. 2 is a perspective view showing a head rest main body shown in FIG. 1;

FIG. 3 is a perspective view showing how an operating member is inserted into a first holder shown in FIG. 1;

FIG. 4 is a sectional view of a first base shown in FIG. 1;

FIG. 5 is a plan view of an operating member shown in FIG. 1;

FIG. 6 is a front view of a first stay member shown in FIG. 1;

FIG. 7 is a sectional view showing a state in which the operating member has been inserted into the first holder shown in FIG. 1;

FIG. 8 is a sectional view showing a state in which the height adjustment engaging section and a first groove according to the first embodiment are engaged with each other;

FIG. 9 is a sectional view taken along the line F9-F9 shown in FIG. 8;

FIG. 10 is a sectional view showing a state in which the height adjustment engaging section shown in FIG. 8 has been disengaged from the first groove;

FIG. 11 is a sectional view showing a state in which the slippage preventive engaging section and the slippage preventive locking groove according to the first embodiment has been engaged with each other;

FIG. 12 is a sectional view taken along the line F12-F12 shown in FIG. 11;

FIG. 13 is a sectional view showing a state in which the slippage preventive engaging section shown in FIG. 11 has been disengaged from the slippage preventive locking groove; and

FIG. 14 is a plan view showing an operating member according to a second embodiment of the present invention.

### DETAILED DESCRIPTION OF THE INVENTION

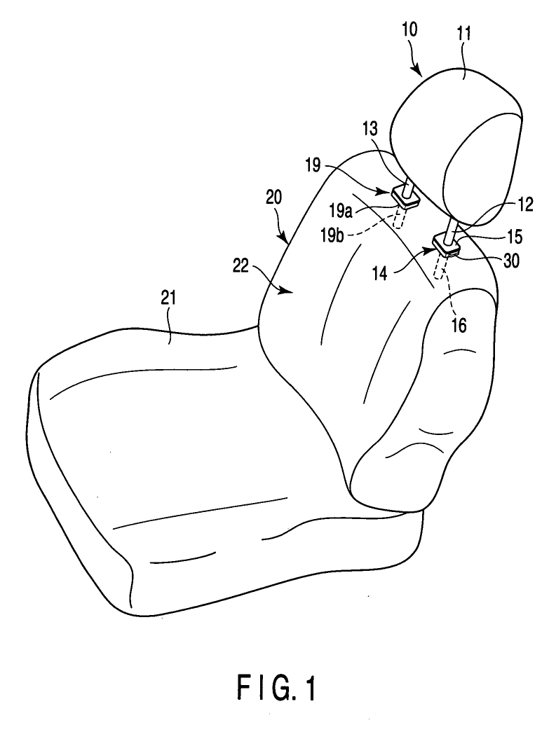

A head rest apparatus according to a first embodiment of the present invention will be described with reference to FIGS. 1 to 13. FIG. 1 shows a seat 20 for which a head rest apparatus 10 is used. The seat 20 is used for an automobile, for example. As shown in FIG. 1, the seat 20 comprises a seat cushion 21, a seat back 22, and the head rest apparatus 10.

The head rest apparatus 10 comprises: a head rest main body 11; a first stay member 12; a second stay member 13; a first holder 14; a second holder 19; an operating member 30; a height adjustment mechanism 40; a slippage preventive mechanism 50; and a screw 60.

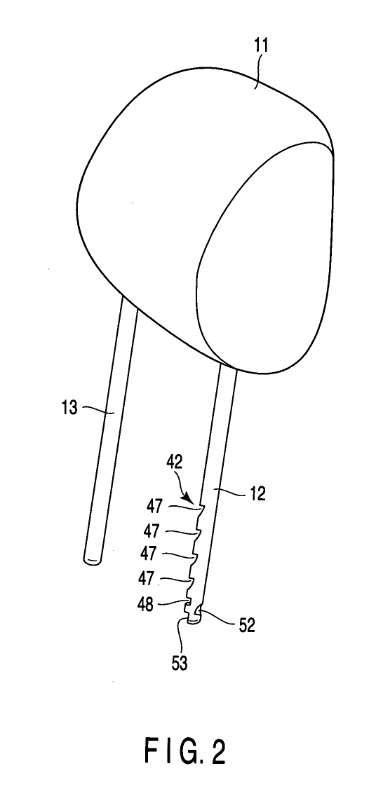

FIG. 2 is a perspective view showing the head rest main body 11, the first stay member 12, and the second stay member 13. As shown in FIG. 2, the first stay member 12 is formed in a bar shape. For example, cross section of the first stay member 12 is substantially circular. The first stay member 12 is provided at the left side of the lower part of the head rest main body 11. The first stay member 12 extends to the seat back 22. The second stay member 13 is formed in a bar shape. For example, cross section of the second stay member 13 is substantially circular. The second stay member 13 is provided at the right side of the lower part of the head rest main body 11. The second stay member 13 extends to the seat back 22.

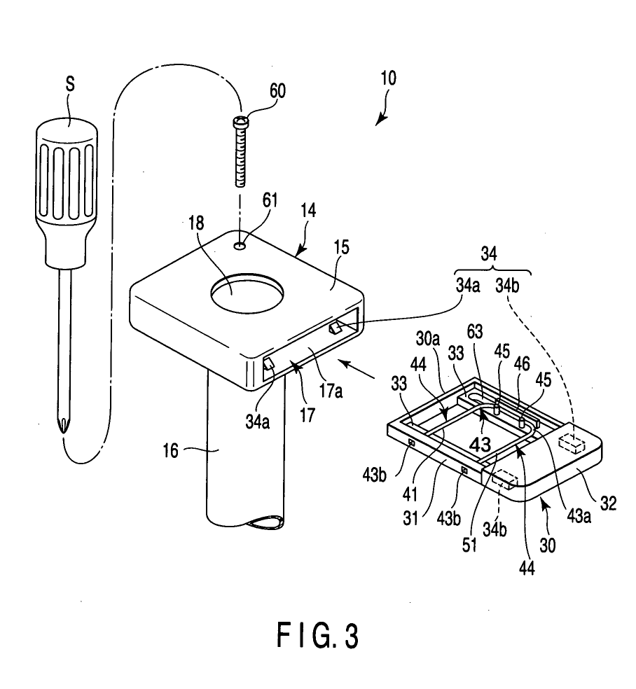

As shown in FIG. 1, the first holder 14 is fixed to the seat back 22 so as to be opposed to the first stay member 12. FIG. 3 is a perspective view showing how an operating member 30 described later is inserted into the first holder.

As shown in FIG. 3, the first holder 14 comprises a first base 15 and a first cylinder section 16. The first base 15 protrudes from the seat back 22 to the outside. The first base 15 is formed in a substantially rectangular shape when it is seen from the top.

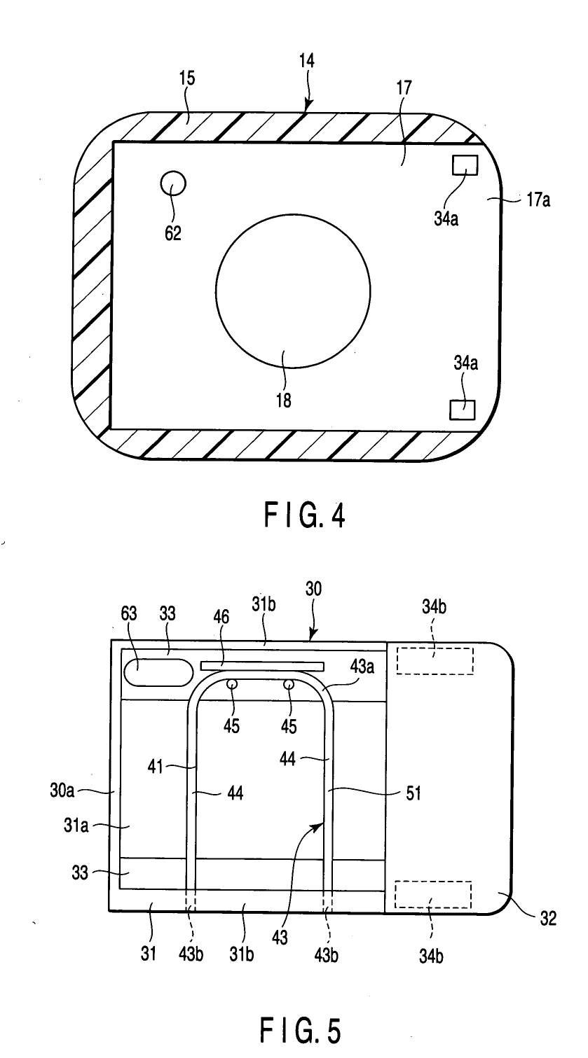

A accommodation section 17 is provided inside of the first base 15. The accommodation section 17 opens at the left side face of the first base 15, for example. FIG. 4 is a sectional view of the first base 15. As shown in FIG. 4, the accommodation section 17 expands inwardly of the first base 15 in a direction crossing the first stay member 12. The operating member 30 described later is movably inserted into the accommodation section 17.

A first through hole 18 is formed at the first base 15. The first through hole 18 passes through the first base 15 from its top face to its bottom face. The first through hole 18 passes through the accommodation section 17. Through the first through hole 18, the first stay member 12 is movably inserted in an axial direction.

As shown in FIG. 3, the first cylinder section 16 is provided on a bottom face of the first base 15, and extends downwardly. As shown in FIG. 1, the first cylinder section 16 is fixed to the seat back 22. The first cylinder section 16 is communicated with the first through hole 18. The first cylinder section 16 house the first stay member 12 movably in an axial direction.

As shown in FIG. 1, the second holder 19 is fixed to the seat back 22 so as to be opposed to the second stay member 13. The second holder 19 comprises a second base 19a and a second cylinder section 19b. The second base 19a protrudes from the seat back 22 to the outside. The second base 19a is formed in a substantially rectangular shape when it is seen from the top.

The second cylinder section 19b is provided on the bottom face of the second base 19a, and extends downwardly. The second cylinder section 19b is fixed to the seat back 22. The second holder 19 houses the second stay member 13 movably in an axial direction.

FIG. 5 is a plan view of the operating member 30. As shown in FIG. 5, the operating member 30 comprises an operating frame body 31 and an operating grip section 32. The operating frame body 31 is formed in a substantially rectangular shape when it is seen from the top. An opening section 31a is formed inside of the operating frame body 31. The opening section 31a penetrates the operating member 30.

One end of the operating frame body 31 is provided as a distal end part 30a to be first inserted into the accommodation section 17. The operating grip section 32 is provided at the other end part of the operating frame body 31.

The opening section 31a has a pair of edges 31b. Each edge 31b is taken along a direction in which the operating member 30 is inserted into the accommodation section 17. A flange section 33 is provided at each edge 31b. Each flange section 33 extends from the operating grip section 32 to the distal end part 30a. Each flange section 33 has a predetermined area inwardly of the opening section 31. A gap through which the first stay member 12 can be sufficiently inserted is defined between one flange section 33 and the other flange section 33.

The operating member 30 is prevented from being slipped off from the inside of the accommodation section 17 by means of an engaging mechanism 34. As shown in FIG. 3, the engaging mechanism 34 comprises a locking claw section 34a and a locking groove 34b. As shown in FIG. 4, the locking claw section 34a is provided in one pair on the bottom face of the opening section 17a of the accommodation section 17. The locking claw section 34a protrudes upwardly.

As shown in FIGS. 3 and 5, a locking groove 34b is formed on the bottom face of the operating grip section 32. The locking groove 34b is recessed upwardly. The locking groove 34b is opposed to the locking claw section 34a when the operating member 30 is inserted into the accommodation section 17. Therefore, the locking groove 34b is engaged with the locking claw section 34a when the operating member 30 is inserted into the accommodation section 17.

The locking groove 34b is formed to be longer than the locking claw section 34a along the direction in which the operating member 30 is inserted into the accommodation section 17. Thus, the operating member 30 can move the inside of the accommodation section 17 even if the locking claw section 34a and the locking groove 34b are engaged with each other.

When the locking claw section 34a is engaged with the locking groove 34b, the operating grip section 32 is formed so as to partially protrude from the opening section 17a of the accommodation section 17 to the outside.

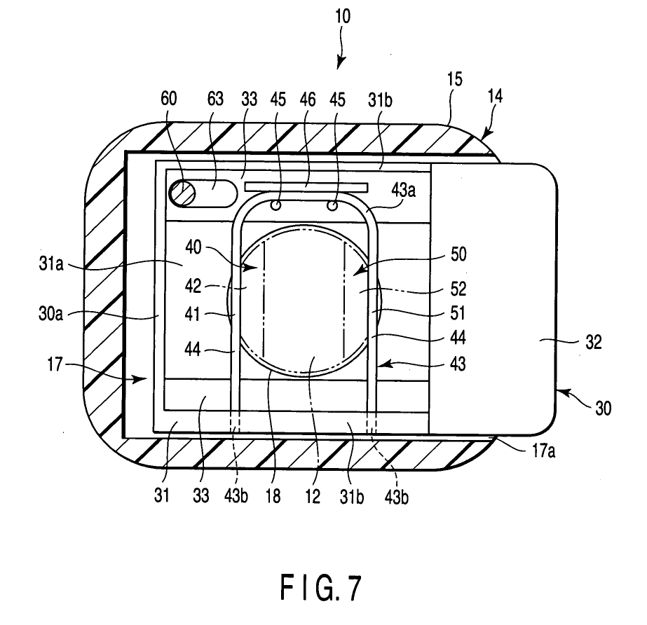

FIG. 7 is a sectional view showing a state in which the operating member 30 is inserted into the first holder 14. As shown in FIG. 7, the height adjustment mechanism 40 comprises a height adjustment engaging section 41 and a height adjustment locking groove section 42.

The height adjustment engaging section 41 is provided at a spring member 43. This spring member 43 is fixed to the operating member 30. The spring member 43 is formed in a substantially circular bar shape, for example, at its cross section. The spring member 43, as shown in FIG. 5, is bent at a curved section 43a, and is formed in a substantially U shape when it is seen from the top.

Each end part 43b of the spring member 43 is fixed into one edge 31b. Namely, each end part 43b is fixed to be inserted through a longitudinal wall of the operating frame body 31 at the side of one flange section 33. A gap between the end parts 43b of the spring member 43 is provided to be narrower than an external diameter of the first stay member 12. The spring member 43 has a pair of straight line sections 44 overhung between the flange sections 33. The straight line sections 44 are arranged in substantially parallel to each other. A gap between one straight line section 44 and the other straight line section 44 is provided to be narrower than the external diameter of the first stay member 12. each straight line section 44 can be bent in a direction in which the operating member 30 moves.

As shown in FIG. 7, when the first stay member 12 is inserted into the first holder 14 while the operating member 30 is inserted into the accommodation section 17, the first stay member 12 is housed between one straight line section 44 and the other straight line section 44.

The height adjustment engaging section 41 is provided at the distal end part 30a side, from among the two straight line sections 44 of the spring member 43.

The curved section 43a of the spring member 43 is fixed to the flange section 33 at the side of the other edge 31b by means of a first fixing member 45 and a second fixing member 46. This fixing structure will be specifically described here.

The first fixing member 45 is provided as a bar member whose cross section is substantially circular, for example. The first fixing member 45 is fixed in one pair to the flange section 33 at one side while the spring member 43 is sandwiched therebetween. The second fixing member 46 is provided as a substantial plate member. The second fixing member 46 is fixed to the flange section 33 at an opposite side of the first fixing member 45 while the spring member 43 is sandwiched therebetween. Thus the spring member 43 is sandwiched between the first fixing member 45 and the second fixing member 46.

As shown in FIG. 7, the height adjustment locking groove section 42 is formed at the side of the height adjustment engaging section 41 in the first stay member 12. When the first stay member 12 is housed in the first holder 14, the height adjustment engaging section 41 side of the first stay member 12 faces the height adjustment engaging section 41.

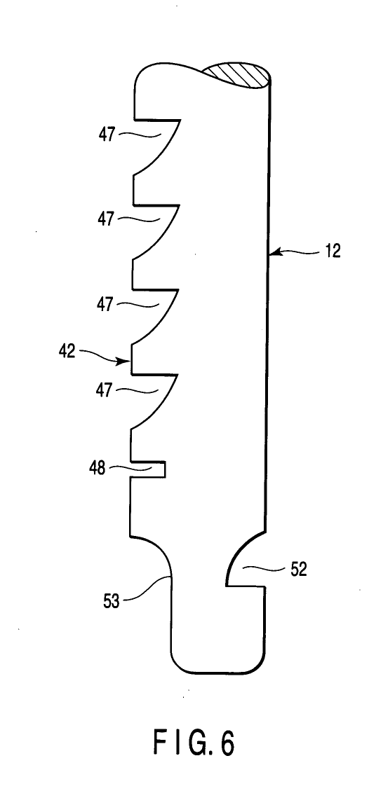

FIG. 6 is a front view of the first stay member 12. As shown in FIG. 6, the height adjustment locking groove section 42 comprises a first groove 47 and a second groove 48. The first groove 47 is formed in plurality at the first stay member 12 along an axial direction of the first stay member 12. An upper end of the first groove 47 is formed in a flat shape crossing the first stay member 12. The first groove 47 is formed in a gently narrowed shape from the upper end to the downward direction. The first groove 47 is engaged with the height adjustment engaging section 41.

The second groove 48 is formed at the stay member 12 more downwardly of the first groove 47. The upper end and the lower end of the second groove 48 are formed in a flat shape crossing the first stay member 12. The second groove 48 is engaged with the height adjustment engaging section 41.

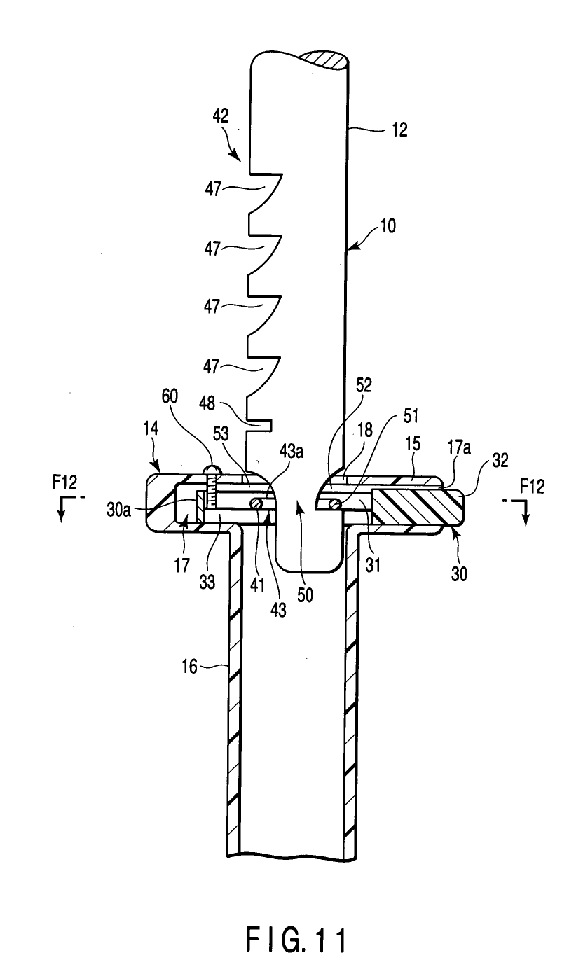

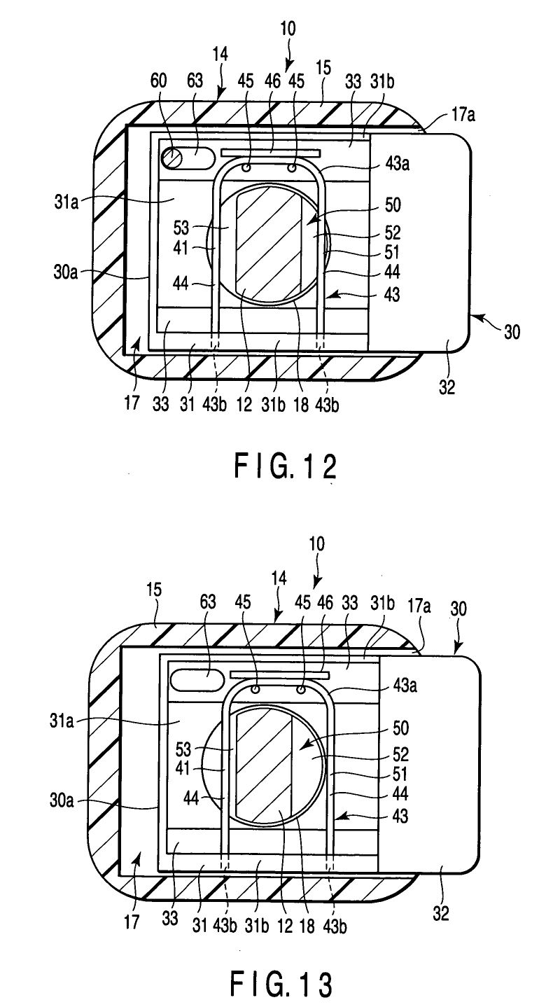

FIG. 11 shows a state in which the first stay member 12 is prevented from slipping off from the first holder 14 by means of the slippage preventive mechanism 50. FIG. 12 is a sectional view taken along the line F12-F12 shown in FIG. 11.

As shown in FIGS. 11 and 12, the slippage preventive mechanism 50 comprises: a slippage preventive engaging section 51; a slippage preventive locking groove 52; and a cutout section 53. The slippage preventive engaging section 51 is provided at one side of the operating grip section 32, from among the straight line sections 44 of the spring member 43. Thus, the height adjustment engaging section 41 and the slippage preventive engaging section 51 faces each other while the first stay member 12 is sandwiched therebetween.

The slippage preventive locking section 52 is formed at the side of the slippage preventive engaging section 51 in the first stay member 12. Namely, the slippage preventive locking groove 52, as shown in FIG. 6, is formed at an opposite side of the height adjustment locking groove section 42.

The slippage preventive locking groove 52 is formed more downwardly of the second groove 48. A lower end of the slippage preventive locking groove 52 is formed in a flat shape crossing the first stay member 12. The slippage preventive locking groove 52 is formed in a shape which is upwardly gently narrowed. The slippage preventive locking groove 52 is engaged with the slippage preventive engaging section 51.

The cutout section 53 is formed at a position opposite to the slippage preventive locking groove 52 at the side of the height adjustment locking groove section 42 of the first stay member 12. The cutout section 53 cuts out the first stay member 12 in a direction crossing the first stay member 12. The cutout section 53 extends to the lower end of the first stay member 12. An upper part of the cutout section 53 is formed in a gentle arc shape.

As shown in FIG. 12, in a state in which the slippage preventive engaging section 51 is engaged with the slippage preventive locking groove 52, the height adjustment engaging section 41 moves into the cutout section 53.

The cutout section 53 is formed by the first stay member 12 being cut out so that the height adjustment engaging section 41 does not abut against a side face of the cutout section 53 even if the operating member is moved until the slippage preventive engaging section 51 is disengaged from the slippage preventive locking groove 52.

The screw 60 is provided as an example of a lock member which inhibits the operating member 30 from moving from a home position to a direction in which the operating member slips off to the outside of the accommodation section 17. The home position of the operating member 30 used here, as shown in FIG. 7, denotes a position at which the height adjustment engaging section 41 can be engaged with the height adjustment locking groove section 42 in a state in which the operating member 30 has been inserted into the accommodation section 17 and a position at which the slippage preventive engaging section 51 can be engaged with the slippage preventive locking groove 52.

When the operating member 30 is set at the home position, a gap between the distal end part 30a of the operating member 30 and a wall face of the accommodation section 17 opposed to the distal end part 30a is determined as a gap in which the operating member 30 is pushed into the accommodation section 17 until the height adjustment engaging section 41 is disengaged from the height adjustment locking groove section 42.

As shown in FIG. 3, the screw 60 reaches a bottom wall of the first base 15 through the operating member 30 from the upper side of a top wall of the first base 15. Specifically, a second through hole 61 is formed on the top wall of the first base 15. When the operating member 30 is set at the home position, the second through hole 61 is formed at a position opposed to the flange section 33 to which one flange section 33, for example, the curved section 43a of the spring member 43 is to be fixed. The second through hole 61 is communicated with the accommodation section 17 in a vertical direction. The screw 60 is inserted through the second through hole 61.

As shown in FIG. 4, a screw hole 62 is formed on a bottom wall of the first base 15. The screw hole 62 overlaps the second through hole 61 in a vertical direction. The screw 60 is spirally fitted to the screw hole 62.

As shown in FIGS. 5 and 7, a third through hole 63 is formed at the flange section 33 which overlaps the second through hole 61 when the operating member 30 is set at the home position. When the operating member 30 is set at the home position, the third through hole 63 is positioned downwardly of the second through hole 61. The screw 60 is inserted through the third through hole 63.

As shown in FIG. 7, the third through hole 63 is formed to be elongated along a direction in which the operating member 30 moves in the accommodation section 17. When the operating member 30 is set at the home position, one end of the distal end part 30a of the third through hole 63 abuts against the screw 60. Whereby, the operating member 30 is inhibited from moving from the home position in a direction in which the operating member slips off from the accommodation section 17.

Thus, even in a state in which the screw 60 has been inserted through the third through hole 63, the operating member 30 can move in a direction in which the operating member 30 is pushed into the accommodation section 17. The third through hole 63 has a length such that the operating member 30 can move until the height adjustment engaging section 41 is disengaged from the height adjustment locking groove section 42.

A locking groove 34b has a length such that the locking claw section 34a can move from a height adjustment release position to a slippage preventive release position. The height adjustment release position used herein denotes a position at which the height adjustment engaging section 41 is disengaged from the height adjustment locking groove section 42. The slippage preventive release position used herein denotes a position at which the slippage preventive engaging section 51 is disengaged from the slippage preventive engaging lock groove 52.

With the above described structure, the operating member 30 functions as an operating member of the height adjustment mechanism 40 and as an operating member of the slippage preventive mechanism 50.

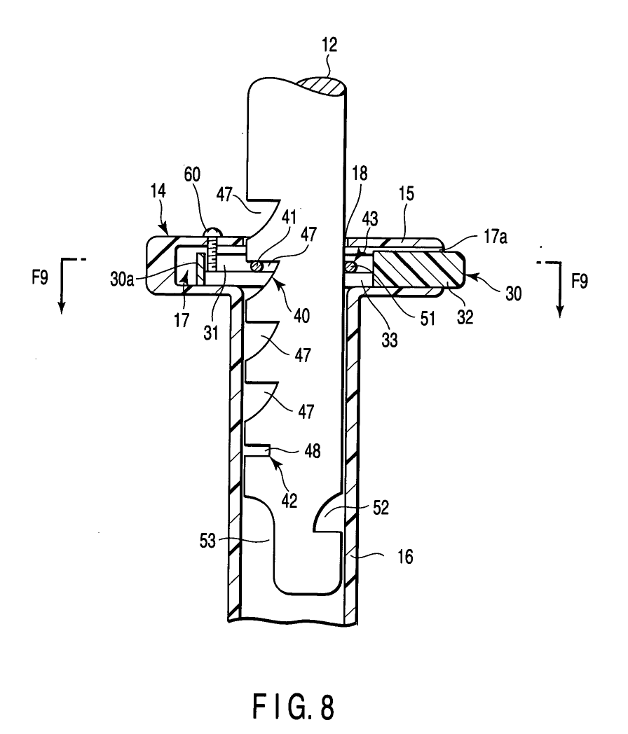

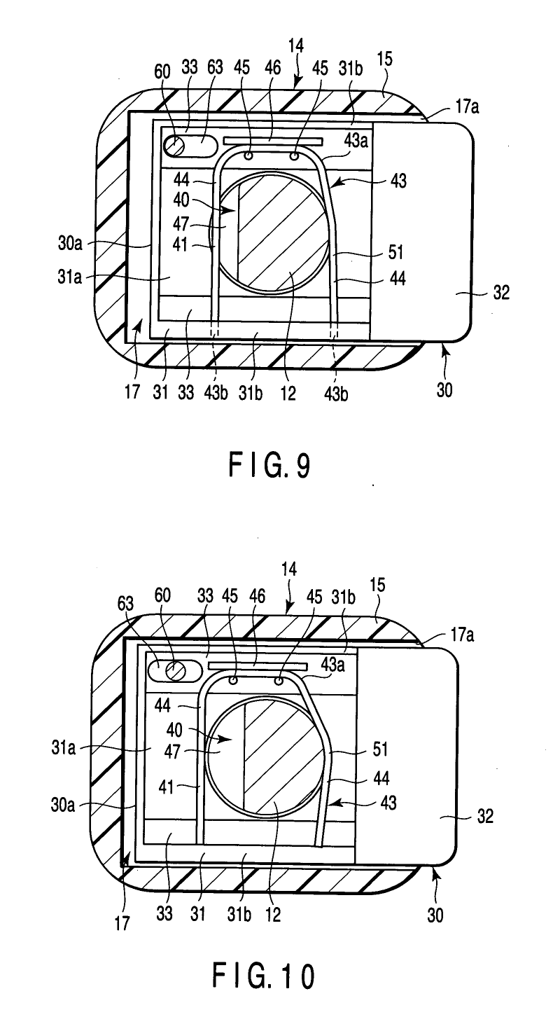

Now, an operation of the head rest apparatus 10 will be described here. FIG. 8 is a sectional view showing a state in which the height adjustment engaging section 41 is engaged with the first groove 47. FIG. 9 is a sectional view taken along the line F9-F9 shown in FIG. 8.

As shown in FIGS. 8 and 9, in a state in which the height adjustment engaging section 41 and the first groove 47 are engaged with each other, and the head part of an occupant is supported by the head rest main body 11, the height adjustment engaging section 41 abuts against an upper end of the first groove 47. The upper end of the first groove 47 is formed in a flat shape. Thus, even if a load is applied from above into the head rest main body 11 in this state, the head rest main body 11 is prevented from being pushed into the first holder 14. At this time, the slippage preventive engaging section 51 abuts against the first stay member 12.

In the case where the position of the head rest main body 11 is lowered, the occupant presses the operating grip section 32 into the accommodation section 17. As shown in FIG. 9, when the operating grip section 32 is pressed, the slippage preventive engaging section 51 bends, whereby the operating member 30 is pushed into the accommodation section 17. As shown in FIG. 10, when the operating grip section 32 is further pressed, the operating member 30 moves to the height adjustment release position.

When the height adjustment engaging section 41 is disengaged from the first groove 47, the first stay member 12 can move inside of the first holder 14 downwardly. When this state is established, the occupant can lower the head rest main body 11 to a desired position.

When the position of the head rest main body 11 is adjusted to the desired position, the occupant stops pressing the operating grip section 32. When the pressed state of the operating grip section 32 is released, the operating member 30 returns to the home position due to resilience of the slippage preventive engaging section 51. Thus, the height adjustment engaging section 41 is engaged with the first groove 47, and the position of the head rest main body 11 is maintained.

If the height adjustment engaging section 41 and the first groove 47 are not opposed to each other, the position of the head rest main body 11 is slightly moved in a vertical direction, whereby the height adjustment engaging section 41 is engaged with the neighboring first groove 47.

In the case where the position of the head rest main body 11 is pulled up, the occupant may lift the head rest main body 11 as it is. The first groove 47 is formed in a gently narrowed shape as the groove goes down. Therefore, the height adjustment engaging section 41 moves along a side face of the first groove 47 without being caught by a top face of the first groove 47. Thus, the occupant can pull up the head rest main body 11.

When the head rest main body 11 is further pulled up, the height adjustment engaging section 41 is engaged with the second groove 48. The second groove 48 is formed in a flat shape crossing the first stay member 12 at the upper and lower ends thereof. Thus, the height adjustment engaging section 41 is caught by the top face of the second groove 48, so that the head rest main body 11 is stopped from being pulled up any more.

In the case where the height adjustment engaging section 41 and the second groove 48 are disengaged from each other, the occupant moves the operating member 30 to the height adjustment release position by pressing the operating grip section 32 into the accommodation section 17. When the height adjustment engaging section 41 is disengaged from the second groove 48, the occupant can further pull up the head rest main body 11.

When the head rest main body 11 is further pulled up, the slippage preventive engaging section 51 is engaged with the slippage preventive locking groove 52, as shown in FIGS. 11 and 12. The slippage preventive locking groove 52 is formed in a flat shape crossing the first stay member 12 at the lower end thereof. Thus, if the slippage preventive engaging section 51 abuts against the lower end of the slippage preventive locking groove 52, the head rest main body 11 is prevented from being pulled out from the seat back 22. At this time, the height adjustment engaging section 41 moves into the cutout section 53.

The slippage preventive locking groove 52 is formed in a shape which is upwardly gently narrowed. Thus, if the head rest main body 11 is pushed, the slippage preventive engaging section 51 moves along a side face, and thus, is disengaged from the slippage preventive locking groove 52.

In the case where the head rest main body 11 is pulled out from the seat back 22, for example, in the case where the seat 20 is pushed down, the occupant removes the screw 60 by using a screwdriver S (shown in FIG. 3). The screwdriver S is provided as an example of a tool.

The screw 60 is removed, whereby the operating member 30 can move so as to slip off from the home position to the outside of the accommodation section. Then, the occupant moves the operating member 30 to the outside of the accommodation section 17 by pulling the operating grip section 32.

As shown in FIG. 13, when the operating member 30 is pulled, the height adjustment engaging section 41 moves into the cutout section 53. When the operating member 30 moves to the slippage preventive release position, the slippage preventive engaging section 51 is disengaged from the slippage preventive locking groove 52. Thus the occupant can pull out the head rest main body 11 from the seat back 22.

In the head rest apparatus 10 having such a structure, in the case where the slippage preventive engaging section 51 and the slippage preventive locking groove 52 are disengaged from each other in order to pull out the head rest main body 11 from the seat back 22, merely removing the screw 60, and then, pulling the operating grip section 32 will suffice.

Namely, the screwdriver S is used to remove the screw 60, and is not used to move the operating member 30 to the slippage preventive release position. Thus, there is no need for providing a tool hole for inserting a tool into the first holder 14. Thus, there is no case in which dust or dirt is clogged into the tool hole or into the first holder 14 through the tool hole. Thereby, there is no case in which head rest main body 11 is not able to pulled out.

Therefore, the head rest apparatus 10 can ensure the safety of the occupant and can pull out the head rest main body 11 as required, for example, in the case where the seat back 22 is pushed down.

In addition, the height adjustment locking groove section 42 and the slippage preventive locking groove 52 are formed at the first stay member 12. Then, the operating member 30 also functions as an operating member of the height adjustment mechanism 40 and an operating member of the slippage preventive mechanism 50. When the operating grip section 32 is pushed into the accommodation section 17, the height adjustment engaging section 41 is disengaged from the height adjustment locking section 42. When the operating member 30 is pulled, the slippage preventive engaging section 51 is disengaged from the slippage preventive locking groove 52.

Namely, the first stay member 12 and the operating member 30 are used commonly in the height adjustment mechanism 40 and the slippage preventive mechanism 50. Thus the height adjustment mechanism 40 and the slippage preventive mechanism 50 are configured with a simple structure.

In addition, the cutout section 53 is provided at the first stay member 12. The cutout section 53 is formed so that its side face does not contact with the height adjustment engaging section 41 even if the operating member 30 is moved until the slippage preventive engaging section 51 is disengaged from the slippage preventive locking groove 52.

Thus, even if the operating member 30 is moved in order to disengage the slippage preventive engaging section 51 from the slippage preventive locking groove 52, there is no case in which the height adjustment engaging section 41 abuts against the first stay member 12. Thereby there is no case in which the operating member 30 is prevented from moving. Therefore, the occupant can pull the operating grip section 32 with gentle force.

As a result, after the screw 60 has been removed, the slippage preventive engaging section 51 is easily disengaged from the slippage preventive locking groove 52. Thus, the head rest main body 11 is easily pulled out from the seat back 22.

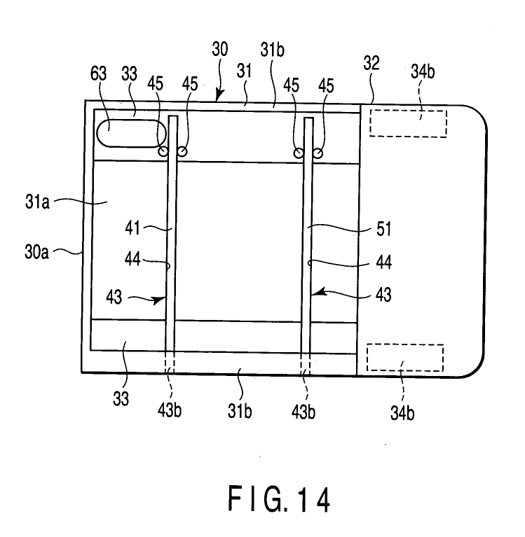

Now, a head rest apparatus 10 according to a second embodiment of the present invention will be described with reference to FIG. 14. The same constituent elements as in the first embodiment are designated by the same reference numerals. And descriptions of the same constituent elements as in the first embodiment are omitted. The present embodiment is different from the first embodiment in terms of the shape of a spring member 43. The difference will be specifically described here.

The spring member 43 is provided in one pair at an operating member 30. Each of the spring members 43 is formed in a straight line shape. Each of the spring member 43 is extends from one edge 31b to other edge 31b. Each of the spring members 43 is arranged in substantially parallel to each other. A gap between the spring members 43 is set to be narrower than an external diameter of a first stay member 12.

One end of each of the spring members 43 is fixed to be inserted into one edge 31b. The other end of each of the spring members 43 is fixed to the flange section 33 at the side of the other edge 31b by means of a first fixing member 45. The first fixing member 45 is used in one pair with respect to one spring member 43. The first fixing members 45 are fixed in one pair to the flange section 33 so as to sandwich the spring member 43 in a thickness direction.

The spring members 43 according to the present embodiment each are formed in a straight line shape. Therefore, each of the spring members 43 also functions as a straight line section 44. The spring member 43 can be bent in a direction in which the operating member 30 moves.

A height adjustment engaging section 41 is provided at the spring member 43 allocated at the side of a distal end 30a. The spring member 43 allocated at the side of a distal end 30a is a second spring member. A slippage preventive engaging section 51 is provided at the other spring member 43. The other spring member 43 is a first spring member. The head rest apparatus 10 according to the present embodiment can attain advantageous effects similar to those of the head rest apparatus 10 according to the first embodiment.

In the first and second embodiments, although the spring member 43 has been formed in a substantially circular shape at its cross section, the sectional shape of the spring member is not limited thereto. The sectional shape of the spring member 43 may be formed in a substantially rectangular shape, for example.

In addition, the height adjustment locking section 42 may be provided at an opposite side to the layout shown in the first and second embodiments. In this case, the slippage preventive locking groove 52 and the cutout section 53 are provided at an opposite side of the height adjustment locking groove section 42. In addition, when the operating member 30 is set at the home position, the third through hole 63 is provided so that an end part of the operating grip section 32 abuts against the screw 60. In addition, the slippage preventive engaging section 51 and the height adjustment engaging section 41 are reversed in position.

In a case in which the height adjustment locking groove section 42, the slippage preventive locking groove 52, and the cutout section 53 are formed at their opposite side, respectively, when the height of the head rest main body 11 is adjusted, the operating grip section 32 is pulled. When the head rest main body 11 is pulled out from the seat back 22, the operating grip section 32 is pushed. In this case as well, similar advantageous effects can be attained.

In addition, in the first and second embodiments, the height adjustment locking groove section 42, the slippage preventive locking groove 52, and the cutout section 53 have been formed at the first stay member 12. In addition, the accommodation section 17 has been formed at the first holder 14. However, the above embodiments are not limited thereto. For example, the height adjustment locking groove section 42, the slippage preventive locking groove 52, and the cutout section 53 may be formed at the second stay member 13. In addition, the accommodation section 17 and the operating member 30 may be provided at the second holder 19. In this case as well, similar advantageous effects can be attained.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A head rest apparatus, comprising:
a head rest main body;
a stay member which is provided at the head rest main body, a slippage preventive locking groove being provided at the stay member;
a holder which is inserted through the stay member and fixed to a seat back, the holder has a hole;
an operating member which is provided at the holder and comprises a slippage preventive engaging section which is engaged with the slippage preventive locking groove, the operating member has a hole, the operating member being movable in a direction crossing the stay member, the slippage preventive engaging section being engageable with the slippage preventive locking groove when the operating member is set at a home position;
an operating grip section which is provided at the operating member and extends from the holder to the outside; and
a lock member which is inserted into the holes that are provided at the holder and the operating member, the lock member being capable of holding the operating member at the home position and removed from the holder and the operating member by means of a tool, the slippage preventive engaging section being disengaged from the slippage preventive locking groove when the lock member is removed and the operating member is moved from the home position to a slippage preventive release position.

2. The head rest apparatus according to claim 1, wherein
the stay member has a height-adjustment locking groove facing away from the slippage-preventive locking groove,
the operating member has a height-adjustment engaging section which engages with the height-adjustment locking groove when the operating member is set at the home position and which is opposed to the slippage preventive engaging section, across the stay member, while the stay member remains the height-adjustment section and the slippage preventive engaging section, and
the hole of the operating member which is inserted through the lock member is elongated hole through which the operating member is to move to a position where the height-adjustment engaging section is disengaged from the height-adjustment locking groove.

3. The head rest apparatus according to claim 2, wherein
the slippage preventive engaging section and the height adjustment engaging section is provided at a spring member which can be bent in a direction in which the operating member moves, the spring member is provide at the operating member.

4. The head rest apparatus according to claim 3, wherein
the spring member is U-shaped and has a pair of straight line section,
the slippage preventive engaging section is provided at one of the straight sections, and
the height-adjustment engaging section is provided at the other straight line section.

5. The head rest apparatus according to claim 2, wherein
the slippage preventive engaging section is provided at a first spring member, the first spring member is provided at the operating member, the first spring member can be bent in a direction in which the operating member moves,
the height-adjustment engaging section is provided at a second spring member, the second spring member is provided at the operating member, the second spring member can be bent in a direction in which the operating member moves.

6. The head rest apparatus according to claim 5, wherein
the first spring member is straight,
the second spring member is straight.

7. The head rest apparatus according to claim 3, wherein
a gap between the slippage preventive engaging section and the height adjustment engaging section is determined to be narrower than a sectional shape of the stay member.

8. The head rest apparatus according to claim 2, wherein
a cutout section is provided at the stay member;
the cutout section is provided at a side identical to the height adjustment locking groove; and
when the operating member is moved to the slippage preventive release position, the height adjustment engaging section can be advanced into the cutout section.

9. The head rest apparatus according to claim 8, wherein
the cutout section is formed so that the height adjustment engaging section is not abutted against the stay member even if the operating member is moved to the slippage preventive release position.
